(19) United States
(12) Patent Application Publication
(10) Pub. No.: US 2007/0049455 A1
(43) Pub. Date: Mar. 1, 2007

(54) Drive assembly and motor vehicle equipped with drive assembly

(75) Inventor: Kohjiro Kuramochi, Okazaki-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, TOYOTA-SHI (JP)

(21) Appl. No.: 11/497,356

(22) Filed: Aug. 2, 2006

(30) Foreign Application Priority Data
Aug. 31, 2005 (JP) 2005-251661

(51) Int. Cl. B60K 1/02; B60W 10/08; B60W 10/02

(52) U.S. Cl. 477/3; 477/5

(57) ABSTRACT

In a drive assembly of the invention, a sun gear, a carrier, and a ring gear of a planetary gear are respectively connected to a motor, to a compressor for air conditioning, and to a pulley (a crankshaft of an engine). The carrier is fixed to a casing via a one-way clutch. In this simple structure, the motor uses a reactive force on the casing via the one-way clutch to output a torque to the engine and accordingly crank the engine. The torques of the engine 22 and the motor are output to the compressor for air conditioning to drive the compressor. The motor generates electric power from the output power of the engine.

### BACKGROUND OF THE INVENTION

1. Field of the Invention

The present invention relates to a drive assembly and a motor vehicle equipped with the drive assembly.

2. Description of the Prior Art

In one proposed structure of a drive assembly, a sun gear, a carrier, and a ring gear of a planetary gear are respectively connected to a pulley, a compressor, and a motor (see, for example, Japanese Patent Laid-Open Gazette No. 2004-124707). In this drive assembly, a crankshaft of an engine is linked to the pulley via a belt. In operation of the engine, the compressor is driven with the output powers of both the engine and the motor. In a stop of the engine, the compressor is driven with the output power of only the motor. During a high-speed drive of a vehicle, the motor functions as a generator to generate electric power and charge a battery with the generated electric power.

### SUMMARY OF THE INVENTION

This prior art structure of the drive assembly has no route of direct power output from the motor to the pulley and accordingly does not allow the motor for driving the compressor to crank the engine for its start. Especially in motor vehicles with requirement for the effective use of the limited space, a simple structure using a motor is highly demanded to crank the engine for a start.

The object of the invention is thus to provide a drive assembly of simple structure that uses the output power of a motor for cranking an internal combustion engine and for driving an actuator, as well as to provide a motor vehicle equipped with the drive assembly of such simple structure. The object of the invention is also provide a drive assembly of simple structure that uses the output power of a motor for cranking an internal combustion engine and for driving an actuator and that uses the output power of the internal combustion engine for power generation by the motor, as well as to provide a motor vehicle equipped with the drive assembly of such simple structure. The object of the invention is further to enhance the efficiency of a motor in a drive assembly and in a motor vehicle equipped with the drive assembly. The object of the invention is also to attain size reduction of a motor in a drive assembly and in a motor vehicle equipped with the drive assembly.

In order to attain at least part of the above and the other related objects, the drive assembly of the invention and the motor vehicle equipped with the drive assembly have the configurations discussed below.

The present invention is directed to a drive assembly that is connected with an output shaft of an internal combustion engine. The drive assembly includes: a motor that has a rotating shaft and is capable of outputting power both in a normal rotating direction and in a reverse rotating direction; an actuator that has an input shaft and is driven with input power from the input shaft; and a planetary gear that has a first rotational element, a second rotational element, and a third rotational element sequentially aligned in an alignment chart, where the first rotational element is connected with the rotating shaft of the motor, the second rotational element is connected with the input shaft of the actuator and is fixed to a casing via a one-way clutch, and the third rotational element is connected with the output shaft of the internal combustion engine.

In the drive assembly of the invention, the planetary gear has the first rotational element, the second rotational element, and the third rotational element sequentially aligned in the alignment chart. The first rotational element is connected with the rotating shaft of the motor. The second rotational element is connected with the input shaft of the actuator and is fixed to a casing via a one-way clutch. The third rotational element is connected with the output shaft of the internal combustion engine. This simple structure enables the power of the motor to be output to the input shaft of the actuator or to be output to the output shaft of the internal combustion engine. A typical example of the ‘actuator’ in this drive assembly is a compressor for air conditioning. The third rotational element may further be fixed to the casing via a one-way clutch, in addition to the connection with the output shaft of the internal combustion engine.

In one preferable application of the drive assembly of the invention, the planetary gear is arranged to give a higher absolute value of a rotational number difference between the first rotational element and the second rotational element than an absolute value of a rotational number difference between the third rotational element and the second rotational element. This arrangement desirably enhances the operation efficiency of the motor and attains size reduction of the motor.

In one preferable embodiment of the invention, the drive assembly further includes a control module that switches over a control mode among multiple different modes including a start control mode and an actuator control mode. The start control mode controls the motor to crank the internal combustion engine for a start of the internal combustion engine with a reactive force on the casing via the one-way clutch. The actuator control mode controls the motor to drive the actuator with output power of at least the motor between the internal combustion engine and the motor as two power sources. The drive assembly is thus operable with a switchover of the control mode among the multiple different modes including at least the start control mode and the actuator control mode. The multiple different modes may further include a power generation control mode that controls the motor to generate electric power from output power of the internal combustion engine. This simple structure uses the output power of the motor for cranking the internal combustion engine and for driving the actuator, while using the output power of the internal combustion engine for power generation by the motor. The power generation control mode may control the motor to generate electric power at a specific motor rotation speed, which is affected by a rotation speed of the internal combustion engine that is not lower than a predetermined level. This arrangement enhances the power generation efficiency of the motor.

In one preferable structure of the drive assembly of the invention, the planetary gear is a single pinion planetary gear including a sun gear as the first rotational element, a carrier as the second rotational element, and a ring gear as the third rotational element. This attains the simple structure of the drive assembly.

The present invention is also directed to a motor vehicle. The motor vehicle includes: an internal combustion engine; a motor that has a rotating shaft and is capable of outputting power both in a normal rotating direction and in a reverse rotating direction; an actuator that has an input shaft and is driven with input power from the input shaft; and a planetary gear that has a first rotational element, a second rotational element, and a third rotational element sequentially aligned in an alignment chart, where the first rotational element is connected with the rotating shaft of the motor, the second rotational element is connected with the input-shaft of the actuator and is fixed to a casing via a one-way clutch, and the third rotational element is connected with the output shaft of the internal combustion engine.

In the motor vehicle of the invention, the planetary gear has the first rotational element, the second rotational element, and the third rotational element sequentially aligned in the alignment chart. The first rotational element is connected with the rotating shaft of the motor. The second rotational element is connected with the input shaft of the actuator and is fixed to a casing via a one-way clutch. The third rotational element is connected with the output shaft of the internal combustion engine. This simple structure enables the power of the motor to be output to the input shaft of the actuator or to be output to the output shaft of the internal combustion engine. A typical example of the ‘actuator’ in this drive assembly is a compressor for air conditioning. The third rotational element may further be fixed to the casing via a one-way clutch, in addition to the connection with the output shaft of the internal combustion engine.

In one preferable application of the motor vehicle of the invention, the planetary gear is arranged to give a higher absolute value of a rotational number difference between the first rotational element and the second rotational element than an absolute value of a rotational number difference between the third rotational element and the second rotational element. This arrangement desirably enhances the operation efficiency of the motor and attains size reduction of the motor.

In one preferable embodiment of the invention, the motor vehicle further includes a control module that switches over a control mode among multiple different modes including a start control mode and an actuator control mode. The start control mode controls the motor to crank the internal combustion engine for a start of the internal combustion engine with a reactive force on the casing via the one-way clutch. The actuator control mode controls the mode to drive the actuator with output power of at least the motor between the internal combustion engine and the motor as two power sources. The motor vehicle is thus operable with a switchover of the control mode among the multiple different modes including at least the start control mode and the actuator control mode. The multiple different modes may further include a power generation control mode that controls the motor to generate electric power from output power of the internal combustion engine. This simple structure uses the output power of the motor for cranking the internal combustion engine and for driving the actuator, while using the output power of the internal combustion engine for power generation by the motor. The power generation control mode may control the motor to generate electric power at a specific motor rotation speed, which is affected by a rotation speed of the internal combustion engine that is not lower than a predetermined level. This arrangement enhances the power generation efficiency of the motor.

In one preferable structure of the motor vehicle of the invention, the planetary gear is a single pinion planetary gear including a sun gear as the first rotational element, a carrier as the second rotational element, and a ring gear as the third rotational element. This attains the simple structure of the drive assembly.

### BRIEF DESCRIPTION OF THE DRAWINGS

FIG. 1 schematically illustrates the configuration of a hybrid vehicle equipped with a drive assembly in one embodiment of the invention;

FIG. 2 is a flowchart showing a motor drive routine executed by an electronic control unit mounted on the hybrid vehicle of the embodiment;

FIG. 3 is an alignment chart showing torque-rotation speed dynamics of respective rotational elements included in a planetary gear in the course of cranking an engine;

FIG. 4 is an alignment chart showing torque-rotation speed dynamics of the respective rotational elements included in the planetary gear during actuation of a compressor;

FIG. 5 is an alignment chart showing torque-rotation speed dynamics of the respective rotational elements included in the planetary gear while a motor consumes the output power of the engine to generate electric power;

FIG. 6 schematically shows a modified structure of the drive assembly as one modified example; and

FIG. 7 is an alignment chart showing torque-rotation speed dynamics of respective rotational elements included in a planetary gear in the modified structure of the drive assembly.

### DESCRIPTION OF THE PREFERRED EMBODIMENTS

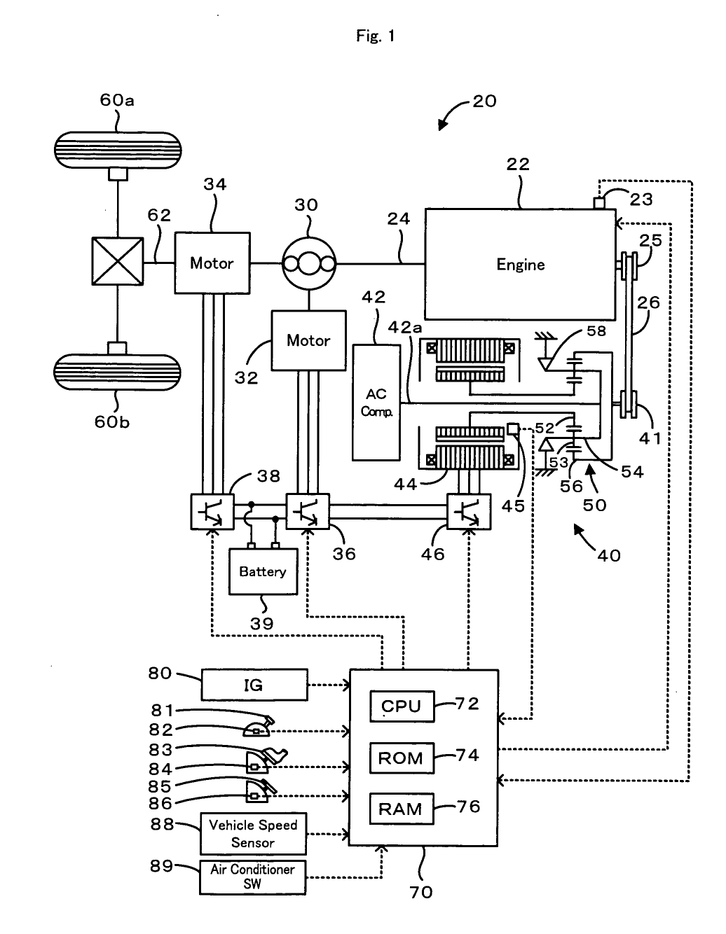

One mode of carrying out the invention is described below as a preferred embodiment with reference to the accompanied drawings. FIG. 1 schematically illustrates the configuration of a hybrid vehicle 20 equipped with a drive assembly 40 in one embodiment of the invention. As illustrated, the hybrid vehicle 20 of the embodiment has an engine 22 that consumes a fuel, such as gasoline or light oil, to output power and a planetary gear 30 that has a carrier linked to a crankshaft 24 of the engine 22 and a ring gear linked to a driveshaft 62 connecting with an axle of wheels 60a and 60b. The hybrid vehicle 20 of the embodiment also includes a motor 32 linked to a sun gear of the planetary gear 30, a motor 34 that outputs power to the driveshaft 62, a drive assembly 40 that is connected with the crankshaft 24 of the engine 22 via pulleys 25 and 41 and a belt 26 spanned between the two pulleys 25 and 41, and an electronic control unit 70 that controls the operations of the whole hybrid vehicle 20. The motors 32 and 34 are constructed as known synchronous motor generators that may be actuated both as a generator and as a motor. The motors 32 and 34 are arranged to transmit electric power to and from a battery 39 via respective inverters 36 and 38.

As illustrated, the drive assembly 40 includes a compressor 42 for air conditioning, a motor 44, a single pinion planetary gear 50 that connects with the crankshaft 24 of the engine 22, with the compressor 42 for air conditioning, and with the motor 44, and a one-way clutch 58. Like the motors 32 and 34, the motor 44 is also constructed as a known synchronous motor generator that may be actuated both as a generator and as a motor. The motor 44 transmits electric power to and from the battery 39 via an inverter 46, which is connected to power lines shared by the inverters 36 and 38. In the structure of the planetary gear 50, a sun gear 52 is connected to the motor 44, and a carrier 54 supporting multiple planetary pinion gears 53 is connected to a rotating shaft 42a of the compressor 42. A ring gear 56 is connected to the crankshaft 24 of the engine 22 via the pulleys 25 and 41 and the belt 26. The planetary gear 50 has a gear ratio ρ (=number of teeth of the sun gear 52/number of teeth of the ring gear 56) adjusted to give the higher absolute value of a rotation number difference between the sun gear 52 and the carrier 54 than the absolute value of a rotation number difference between the ring gear 56 and the carrier 54. The carrier 54 of the planetary gear 30 is fixed to a casing via the one-way clutch 58. The one-way clutch 58 is released in rotations of the carrier 54 in a positive direction and is locked in rotations of the carrier 54 in a negative direction, where the normal rotating direction of the engine 22 is defined as the positive direction.

The electronic control unit 70 is constructed as a microprocessor including a CPU 72, a ROM 74 that stores processing programs, a RAM 76 that temporarily stores data, input and output ports (not shown), and a communication port (not shown). The electronic control unit 70 receives, via its input port, an ignition signal from an ignition switch 80, a gearshift position SP or a current setting position of a gearshift lever 81 from a gearshift position sensor 82, an accelerator opening Acc or the driver's depression amount of an accelerator pedal 83 from an accelerator pedal position sensor 84, a brake pedal position BP or the driver's depression amount of a brake pedal 85 from a brake pedal position sensor 86, a vehicle speed V from a vehicle speed sensor 88, a rotation speed Ne of the engine 22 from a rotation speed sensor 23, and a rotational position of a rotor in the motor 44 from a rotational position detection sensor 45. The electronic control unit 70 outputs, via its output port, control signals to the engine 22 and switching control signals to switching elements included in the respective inverters 36, 38, and 46.

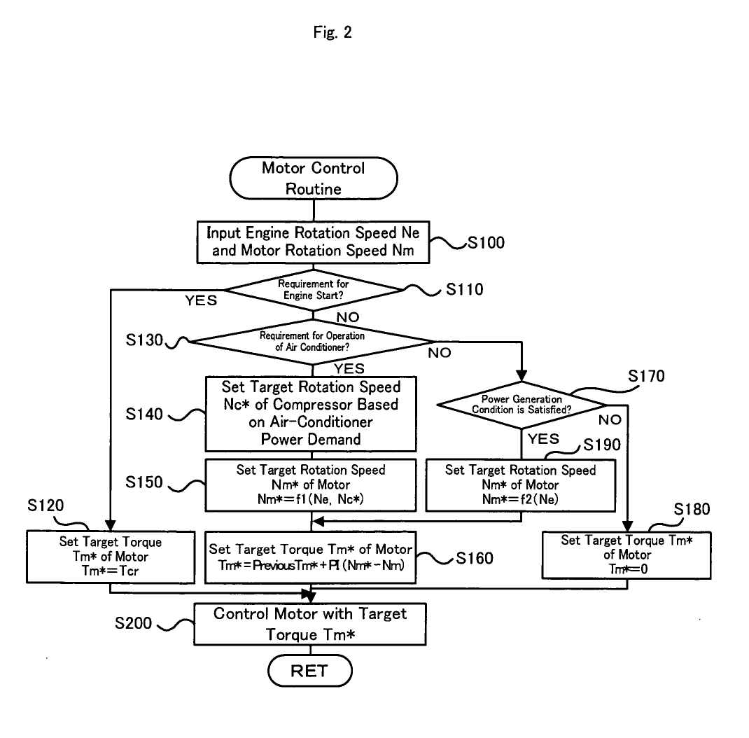

The description regards the operations of the hybrid vehicle 20 of the embodiment having the configuration discussed above, especially a series of control of the motor 44 included in the drive assembly 40 of the embodiment. FIG. 2 is a flowchart sowing a motor drive routine executed by the CPU 72 of the electronic control unit 70. This motor control routine is carried out repeatedly at preset time intervals, for example, at every several msec.

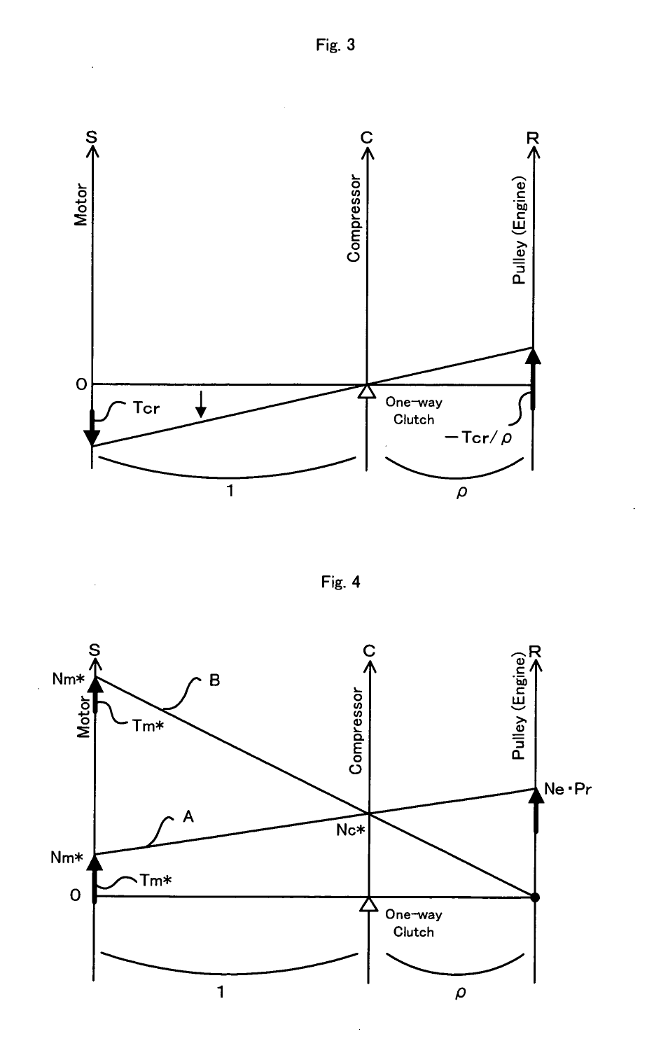

In the motor control routine, the CPU 72 of the electronic control unit 70 first inputs data required for control, that is, the rotation speed Ne of the engine 22 from the rotation speed sensor 23 and a rotation speed Nm of the motor 44 (step S100). The input rotation speed Nm of the motor 44 is computed from the rotational position of the rotor in the motor 44 detected by the rotational position detection sensor 45. The CPU 72 subsequently identifies the requirement for a start of the engine 22 (step S110). Upon requirement for a start of the engine 22 at step S110, a cranking torque Tcr as a torque required for cranking the engine 22 is set to a target torque Tm* of the motor 44 (step S120). The CPU 72 then controls the operation of the motor 44 with the set target torque Tm* (step S200) and exits from this motor control routine of FIG. 2. FIG. 3 is an alignment chart showing torque-rotation speed dynamics of the respective rotational elements included in the planetary gear 50 in this state. The left axis ‘S’ represents the rotation speed of the sun gear 52 that is equivalent to the rotation speed Nm of the motor 44. The middle axis ‘C’ represents the rotation speed of the carrier 54 that is equivalent to the rotation speed Nc of the compressor 42. The right axis ‘R’ represents the rotation speed of the ring gear 56 that is equivalent to the product of the rotation speed of the pulley 41 or the rotation speed Ne of the engine 22 and a pulley ratio Pr of the pulley 25 to the pulley 41. As shown in the alignment chart of FIG. 3, a downward (in the drawing) cranking torque Tcr is output from the motor 44 to the sun gear 52 to lock the one-way clutch 58. This leads to application of an upward (in the drawing) torque (−Tcr/ρ) to the ring gear 56 to crank the engine 22. Here ‘ρ’ denotes the gear ratio of the planetary gear 50 as mentioned previously. The output torque of the motor 44 is amplified before application to the ring gear 56. The motor 44 of even a relatively low capacity is thus sufficient for cranking the engine 22. The concrete procedure of the operation control of the motor 44 performs switching control of the switching elements included in the inverter 46 to ensure output of a torque equivalent to the target torque Tm* from the motor 44.

Upon non-requirement for a start of the engine 22 at step S110, on the other hand, the CPU 72 subsequently identifies the requirement for operation of an air conditioner (step S130). The identification of this requirement is based on the on-off operation of an air conditioner switch 89. Upon requirement for operation of the air conditioner at step S130, a target rotation speed Nc* of the compressor 42 is set based on an air-conditioner power demand (step S140) The concrete procedure of this embodiment uses a map to set the target rotation speed Nc*. The map is designed to give the higher target rotation speed Nc* of the compressor 42 with an increase in air-conditioner power demand. The air-conditioner power demand depends upon the setting value of a temperature setting switch (not shown), the outside temperature, and the vehicle inside temperature. The CPU 72 calculates a target rotation speed Nm* of the motor 44 from the set target rotation speed Nc* of the compressor 42, the rotation speed Ne of the engine 22 input at step S100, the pulley ratio Pr, and the gear ratio ρ of the planetary gear 50 according to Equation (1) given below (step S150):
Nm*=Nc*·(1+ρ)/ρ−Ne·Pr/ρ (1)
The CPU 72 subsequently calculates the target torque Tm* of the motor 44 from the set target rotation speed Nm* of the motor 44 and the current rotation speed Nm of the motor 44 input at step S100 according to Equation (2) given below (step S160):
Tm*=Previous Tm*+kp·(Nm*−Nm)+ki∫(Nm*−Nm)dt (2)
The CPU 72 then controls the operation of the motor 44 with the set target torque Tm* (step 200) and exits from the motor control routine of FIG. 2. FIG. 4 is an alignment chart showing torque-rotation speed dynamics of the respective rotational elements included in the planetary gear 50 in this state. In the alignment chart of FIG. 4, a solid line A represents the operation state of the engine 22 to drive the compressor 42 with the output powers of both the engine 22 and the motor 44. A solid line B represents the stop state of the engine 22 to drive the compressor 42 with the output power of only the motor 44. Equation (1) is readily obtained from the rotation speed relation in the alignment chart of FIG. 4. Equation (2) is a relational expression of feedback control to drive and rotate the motor 44 at the target rotation speed Nm*. In Equation (2) given above, ‘kp’ in the second term and ‘ki’ in the third term on the right side respectively denote a gain of the proportional and a gain of the integral term. As shown by the solid line B, in the stop state of the engine 22, the motor 44 drives the compressor 42 with the engine loading as a reactive force. According to the specification of the compressor 42, upper guards may be set on the target torque Tm* of the motor 44 and on the target rotation speed Nc* of the compressor 42 in order to ensure the operation of the compressor 42 within the range of the engine loading in the stop state of the engine 22. The target torque Tm* of the motor 44 may be set to drive the compressor 42 at a preset low rotation speed.

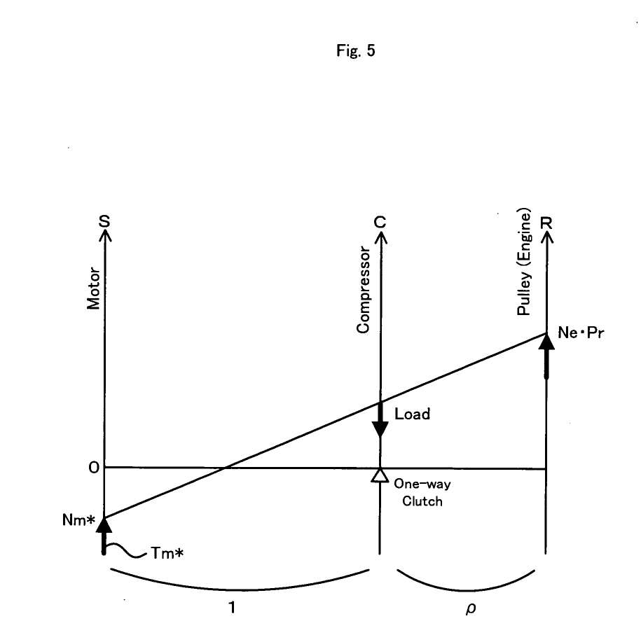

Upon non-requirement for operation of the air conditioner at step S130, on the other hand, the CPU 72 subsequently determines satisfaction or failure of preset power generation conditions to allow power generation by the motor 44 (step S170). The power generation conditions are, for example, whether the rotation speed Ne of the engine 22 is not lower than a specified level required for power generation by the motor 44 and whether the battery 39 is in a chargeable state. When the preset power generation conditions of the motor 44 are not satisfied at step S170, the target torque Tm* is set equal to 0 to stop the torque output from the motor 44 (step S180). The CPU 72 then controls the operation of the motor 44 with the set target torque Tm* (step 200) and exits from the motor control routine of FIG. 2. When the preset power generation conditions of the motor 44 are satisfied at step S170, on the other hand, the target rotation speed Nm* of the motor 44 is set according to the rotation speed Ne of the engine 22 input at step S100 (step S190). The procedure of this embodiment decreases the target rotation speed Nm* of the motor 44 (that is, increases the absolute value of the target rotation speed |Nm*|) with an increase in rotation speed Ne of the engine 22. This is because the operation of the motor 44 at a rotation speed of a higher absolute value enhances the efficiency of power generation. The CPU 72 subsequently calculates the target torque Tm* of the motor 44 from the set target rotation speed Nm* of the motor 44 and the current rotation speed Nm of the motor 44 input at step S100 according to Equation (2) given above (step S160). The CPU 72 then controls the operation of the motor 44 with the set target torque Tm* (step 200) and exits from the motor control routine of FIG. 2. FIG. 5 is an alignment chart showing torque-rotation speed dynamics of the respective rotational elements included in the planetary gear 50 in this state. A torque applied to the sun gear 52 by the rotational resistance of the compressor 42 in the operation of the motor 44 at a negative rotation speed is compensated by a positive torque output from the motor 44. The motor 44 is then driven at a negative rotation speed and a positive torque to generate electric power. The gear ratio ρ of the planetary gear 50 is adjusted to give the higher absolute value of the rotation number difference between the sun gear 52 and the carrier 54 than the absolute value of the rotation number difference between the ring gear 56 and the carrier 54. Such adjustment enables the motor 44 to be driven at a rotation speed of a higher absolute value and thus desirably enhances the efficiency of power generation.

In the hybrid vehicle 20 of the embodiment described above, the sun gear 52, the carrier 54, and the ring gear 56 of the planetary gear 50 are respectively connected to the motor 44, to the compressor 42 for air conditioning, and to the crankshaft 24 of the engine 22. The carrier 54 is fixed to the casing via the one-way clutch 58. In this simple structure, the motor 44 works to drive the compressor 42 for air conditioning, to crank the engine 22, and to generate electric power from the output power of the engine 22. The gear ratio ρ of the planetary gear 50 is adjusted to give the higher absolute value of the rotation number difference between the sun gear 52 and the carrier 54 than the absolute value of the rotation number difference between the ring gear 56 and the carrier 54. This arrangement enables amplification of the output torque of the motor 44 to crank the engine 22 and power generation of the motor 44 at a rotation speed of a higher absolute value. This desirably enhances the efficiency of the motor 44 and attains size reduction of the motor 44.

In the hybrid vehicle 20 of the embodiment, the motor 44 uses the output power of the engine 22 to generate electric power. The power generation by the motor 44 is, however, not essential.

In the hybrid vehicle 20 of the embodiment, the sun gear 52, the carrier 54, and the ring gear 56 of the planetary gear 50 are respectively connected to the motor 44, to the compressor 42 for air conditioning, and to the crankshaft 24 of the engine 22. The carrier 54 is fixed to the casing via the one-way clutch 58. One possible modification may additionally fix the sun gear 52 to the casing via a one-way clutch. In this modified structure, in the stop state of the engine 22, the motor 44 actuates the compressor 42 with a reactive force on the casing via the one-way clutch.

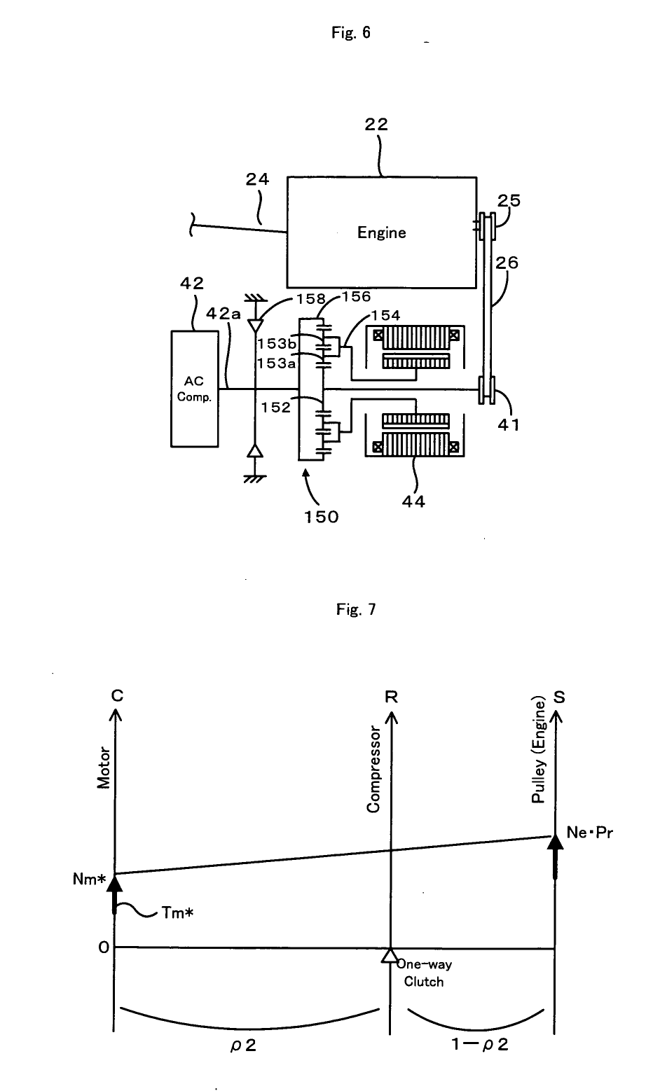

The hybrid vehicle 20 of the embodiment uses the single pinion planetary gear 50 for connection with the motor 44, the compressor 42 for air conditioning, the one-way clutch 58, and the crankshaft 24 of the engine 22. Another connection structure may alternatively be adopted to sequentially connect with the motor 44, the compressor 42 for air conditioning, the one-way clutch 58, and the crankshaft 24 of the engine 22 in an alignment chart. For example, the connection with the motor 44 and the connection with the crankshaft 24 of the engine 22 may be reversed in the planetary gear 50. Another possible modification may use a double pinion planetary gear 150 as shown in FIG. 6. In this modified structure, the crankshaft 24 of the engine 22 is connected with a sun gear 152 of the planetary gear 150 via the pulley 41, the belt 26, and the pulley 25. The motor 44 is connected with a carrier 154 that supports a first planetary pinion gear 153a and a second planetary pinion gear 153b. A ring gear 156 is connected with the compressor 42 for air conditioning and is fixed to the casing via a one-way clutch 158. FIG. 7 is an alignment chart showing torque-rotation speed dynamics of the respective rotational elements included in the planetary gear 150 of this modified structure. In the alignment chart of FIG. 7, ‘ρ2’ denotes a gear ratio of the planetary gear 150 (=number of teeth of the sun gear 152/number of teeth of the ring gear 156). A further possible modification may reverse the connection with the motor 44 and the connection with the crankshaft 24 of the engine 22 in the planetary gear 150.

In the hybrid vehicle 20 of the embodiment, the compressor 42 for air conditioning is driven with the output power of the motor 44. The output power of the motor 44 may be used to actuate or drive any other suitable device, in place of or in addition of the compressor 42 for air conditioning.

In the embodiment described above, the drive assembly 40 is mounted on the hybrid vehicle 20 equipped with the engine 22, the planetary gear 30, and the two motors 32 and 34. The drive assembly of the invention may be mounted a motor vehicle of any other configuration including an internal combustion engine or may be mounted on any of diverse moving bodies including various cars and vehicles, ships and boats, and aircraft as well as diverse stationary equipment including construction machines.

The embodiment and its modified examples discussed above are to be considered in all aspects as illustrative and not restrictive. There may be many other modifications, changes, and alterations without departing from the scope or spirit of the main characteristics of the present invention.

The disclose of Japanese Patent Application No. 2005-251661 filed Aug. 31, 2005 including specification, drawings and claims is incorporated herein by reference in its entirety.

What is claimed is:

1. A drive assembly that is connected with an output shaft of an internal combustion engine,
said drive assembly comprising:
a motor that has a rotating shaft and is capable of outputting power both in a normal rotating direction and in a reverse rotating direction;
an actuator that has an input shaft and is driven with input power from the input shaft; and
a planetary gear that has a first rotational element, a second rotational element, and a third rotational element sequentially aligned in an alignment chart, where the first rotational element is connected with the rotating shaft of the motor, the second rotational element is connected with the input shaft of the actuator and is fixed to a casing via a one-way clutch, and the third rotational element is connected with the output shaft of the internal combustion engine.

2. A drive assembly in accordance with claim 1, wherein the planetary gear is arranged to give a higher absolute value of a rotational number difference between the first rotational element and the second rotational element than an absolute value of a rotational number difference between the third rotational element and the second rotational element.

3. A drive assembly in accordance with claim 1, said drive assembly further comprising:
a control module that switches over a control mode among multiple different modes including a start control mode and an actuator control mode, where the start control mode controls the motor to crank the internal combustion engine for a start of the internal combustion engine with a reactive force on the casing via the one-way clutch, and the actuator control mode controls the motor to drive the actuator with output power of at least the motor between the internal combustion engine and the motor as two power sources.

4. A drive assembly in accordance with claim 3, wherein the multiple different modes further include a power generation control mode that controls the motor to generate electric power from output power of the internal combustion engine.

5. A drive assembly in accordance with claim 4, wherein the power generation control mode controls the motor to generate electric power at a specific motor rotation speed, which is affected by a rotation speed of the internal combustion engine that is not lower than a predetermined level.

6. A drive assembly in accordance with claim 1, wherein the actuator is a compressor for air conditioning.

7. A drive assembly in accordance with claim 1, wherein the planetary gear is a single pinion planetary gear including a sun gear as the first rotational element, a carrier as the second rotational element, and a ring gear as the third rotational element.

8. A motor vehicle, comprising:
an internal combustion engine;
a motor that has a rotating shaft and is capable of outputting power both in a normal rotating direction and in a reverse rotating direction;
an actuator that has an input shaft and is driven with input power from the input shaft; and
a planetary gear that has a first rotational element, a second rotational element, and a third rotational element sequentially aligned in an alignment chart, where the first rotational element is connected with the rotating shaft of the motor, the second rotational element is connected with the input shaft of the actuator and is fixed to a casing via a one-way clutch, and the third rotational element is connected with the output shaft of the internal combustion engine.

9. A motor vehicle in accordance with claim 8, wherein the planetary gear is arranged to give a higher absolute value of a rotational number difference between the first rotational element and the second rotational element than an absolute value of a rotational number difference between the third rotational element and the second rotational element.

10. A motor vehicle in accordance with claim 8, said drive assembly further comprising:
a control module that switches over a control mode among multiple different modes including a start control mode and an actuator control mode, where the start control mode controls the motor to crank the internal combustion engine for a start of the internal combustion engine with a reactive force on the casing via the one-way clutch, and the actuator control mode controls the mode to drive the actuator with output power of at least the motor between the internal combustion engine and the motor as two power sources.

11. A motor vehicle in accordance with claim 10, wherein the multiple different modes further include a power generation control mode that controls the motor to generate electric power from output power of the internal combustion engine.

12. A motor vehicle in accordance with claim 11, wherein the power generation control mode controls the motor to generate electric power at a specific motor rotation speed, which is affected by a rotation speed of the internal combustion engine that is not lower than a predetermined level.

13. A motor vehicle in accordance with claim 8, wherein the actuator is a compressor for air conditioning.

14. A motor vehicle in accordance with claim 8, wherein the planetary gear is a single pinion planetary gear including a sun gear as the first rotational element, a carrier as the second rotational element, and a ring gear as the third rotational element.
